(19) United States
(12) Patent Application Publication
(10) Pub. No.: US 2014/0228074 A1
(43) Pub. Date: Aug. 14, 2014

(54) Embedded Accessory for Mobile Devices

(71) Applicants: Shreevallabha N Kulkarni, Bangalore (IN); Kuruvanghat Krishnakumar, Bangalore (IN); Thomas Hornung, Sarnen (CH)

(72) Inventors: Shreevallabha N Kulkarni, Bangalore (IN); Kuruvanghat Krishnakumar, Bangalore (IN); Thomas Hornung, Sarnen (CH)

(73) Assignee: Sonim Technologies, Inc., San Mateo, CA (US)

(21) Appl. No.: 13/764,913

(22) Filed: Feb. 12, 2013

(51) Int. Cl. H04M 1/02

(52) U.S. Cl. CPC H04M 1/0274
USPC 455/557

(57) ABSTRACT

A method and system for enabling an external module for enterprise application to be embedded to a mobile phone. The external module is provided with a microcontroller configured with a plurality of serial buses and a device driver together implemented in the battery cover of the mobile phone. A generic driver is implemented to support various serial communication interfaces and data exchanges. Further, the external module communicates with the mobile phone using an operating system (OS) application programming interface (API) on the mobile phone. A data sheet and a software development kit (SDK) are provided for third parties to develop and implement their own accessories to be embedded on this external interface into the mobile phone. Further, specific phone case is equipped to accommodate different module(s)/sub-modules and to retain the combination in a single unit.

### TECHNICAL FIELD

The embodiments herein relate to mobile phones and, more particularly, to providing an interface for an accessory on the mobile phone for connecting modules to the mobile phones.

### BACKGROUND

The usefulness of mobile phones has made it a modern day necessity. With the increasing development in technology, mobile phones today provide a range of high end features such as high resolution touch screens, GPS navigation units, high speed data access via Wi-Fi and mobile broadband and so on.

One high end feature in advanced mobile phones which has been continually developing is external interfacing. External interfacing requires simple connectivity support to perform processing and collection of different data from many accessory types. Certain mobile devices provide accessories which can be fitted to the mobile phone and some also provide mechanisms to attach accessories and programming software. So far the focus of the manufacturers of these mobile devices is on the consumer side and the types of accessories are mostly memory devices (employing Universal Serial Bus (USB) or audio headsets and the like. The USB mode is power consuming and driver integration requires software updates to the mobile phone.

Existing mobile devices provide means for interfacing accessories to the device externally. However, there are some drawbacks associated with such devices. In an example, in order to implement an external processing accessory for the mobile device, an external interface is integrated and is used for external power chargers or for communication purposes. Further, the device may also be equipped with a programmable smart card interface built into the mobile accessory and an operating system provided for communicating from the external interface to the mobile phone. The disadvantages of this mechanism are that there is no means for driver integration and development of applications and accessories for the mobile phone by third parties.

In another existing mechanism for developing wireless device applications for the mobile device using an integrated emulator, a micro controller is used as an interface and an Operating system API is used for communication between the external interface and the mobile phone. Further, this mechanism provides a software development kit (SDK) for the third party user and third party users can develop and implement applications for the mobile phone. The disadvantages of this system are that the features do not allow driver integration and accommodating different external modules into a specific mobile phone. Further, there is requirement of additional connector pins in order to support the interfaces.

In light of these disadvantages, it can be inferred that enterprise accessories come with various interface connectivity requirements. If a mobile phone has to support all such interfaces, it would result in a complex specification requiring about a 20-30 pin connector. Further, the number of pins increases the design complexity of the mobile phone's PCB. The software level complexity is also increased in order to support drivers and software extensions to support various kinds of accessories over multiple interfaces. In terms of device hardware requirements, the existing designs do not provide a unified integration of the accessory on the mobile phones. Due to this, additional hardware is required for integration purposes.

Considering all these facts, it is necessary to come up with a system which provides a standardized mechanism of communication to accessories and performs independent hardware and software development to result in a unified and ruggedized mobile device. The system must provide the capability to integrate different accessories on the mobile phone without the need of some additional hardware.

### SUMMARY

In view of the foregoing, an embodiment herein provides a mobile phone for providing a platform for interfacing an external module. The mobile phone provided with a connector for interfacing the external module to the mobile phone for communication with the external module, an application programming interface on the mobile device for supporting enterprise applications running on the external module and a mobile phone case to enable the combination of the connector and the external module to function as a single unit.

Also provided herein is an external module for supporting enterprise applications on a mobile phone. The module comprising at least one microcontroller programmed for executing enterprise specific application on the module and a device driver residing on the module for supporting serial communications with the mobile phone.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram which shows the various components of a mobile device as disclosed in the embodiments herein;

FIG. 2a is a block diagram which depicts the connector architecture on the mobile phone, as disclosed in the embodiments herein;

FIG. 2b is a block diagram which depicts the external module interface architecture as disclosed in the embodiments herein;

FIG. 3 is an exemplary diagram of the serial communication mechanism and the API on the mobile phone, as disclosed in the embodiments herein;

FIG. 4 illustrates the side view of the mobile phone and the external module interfaced to the battery cover, as disclosed in the embodiments herein;

FIG. 5 is an exemplary diagram which illustrates the authentication mechanism as disclosed in the embodiments herein; and

FIG. 6 is a block diagram of a generic mobile device architecture.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

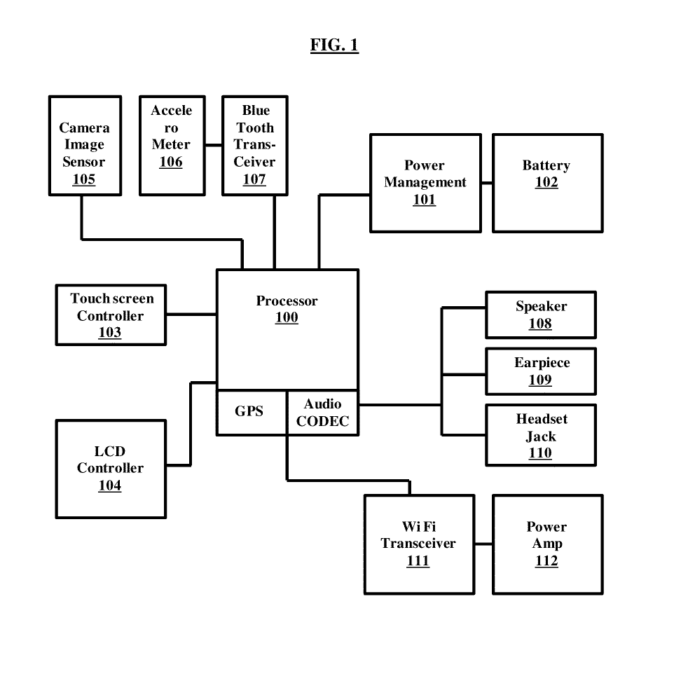

The embodiments herein disclose a method and system for providing a unified interface accessory that allows various modules to be connected to the mobile phone as per the requirements of enterprise. Referring now to the drawings, and more particularly to FIGS. 1 through 6, where similar reference characters denote corresponding features consistently throughout the figures, there are shown embodiments.

In an embodiment, the term external module may refer to Battery Cover Accessory throughout the usage.

FIG. 1 illustrates a block diagram which shows the various components of a mobile device as disclosed in the embodiments herein. The system comprises a Processor 100, a power management module 101, battery 102, touch screen controller 103, LCD controller 104, camera image sensor 105, accelerometer 106, Bluetooth transceiver 107, speaker 108, earpiece 109, headset jack 110, Wi-Fi transceiver 111 and power amp 112.

The processor 100 comprises of a base band processor and an application processor. The base band processor is an IC that is mainly used in a mobile phone to process communication functions. Typically, the baseband processor 100 comprises the control circuitry (micro processor), the power supply and the amplifiers. Application processor 100 enables the working of operating systems in a mobile phone, supports connectivity to personal computers and various audio and video applications.

The power management module 101 comprises plurality of power supply ICS which minimize power consumption while maintaining the necessary functions to protect the system from external interference. Further, the battery 102 provides the power source for the phone functions. The touch screen controller 103 enables the user to interact directly with the displayed parameters. The LCD controller 104 supports the mobile display. Further, the camera image sensor 105 is responsible for conversion of an optical image into an electronic signal.

The accelerometer 106 is used to measure the orientation or vertical and horizontal positioning of the mobile phone. The Bluetooth transceiver 107 encodes the desired file into a Bluetooth friendly format. Further, the speaker 108 translates the electrical signals into audible sound. The earpiece 109 is an aid for listening to the audio transmission which comprises a micro phone module connected in the cable. The headset jack 110 is the jack to connect the ear piece. Further, the Wi-Fi transceiver 111 encodes the desired file into suitable formats. The Power amplifier 112 in mobile phones is used to increase signal power up to levels required for wireless communications.

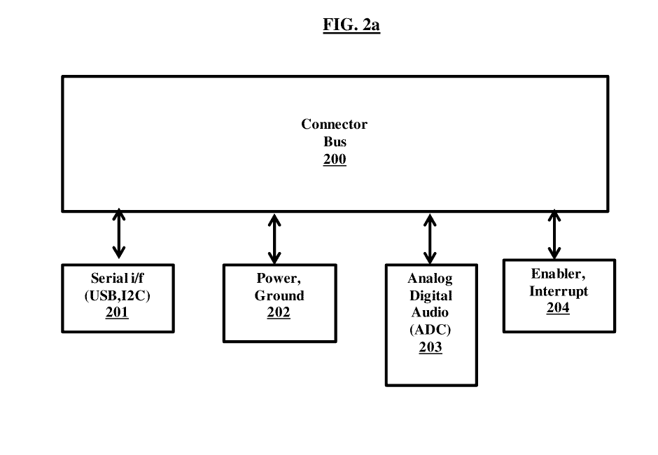

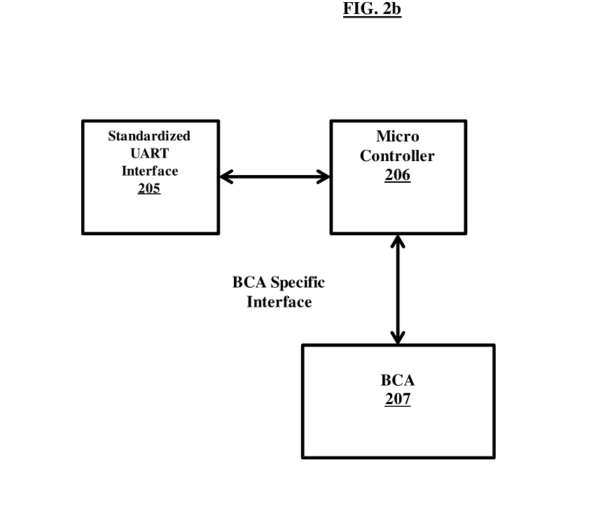

FIG. 2a is a block diagram which depicts the connector architecture on the mobile phone, as disclosed in the embodiments herein. The Connector Bus 200 comprises of a Serial I/F port 201, a ground power connection 202, an analog to digital converter 203 and an interrupt enable 204. The serial I/F port 201 is a serial communication physical interface through which information transfers in or out one bit at a time. Further, the serial I/F port 201 could be in the form of USB, I²C and the like. USB is the industry standard bus used to define the cables, connectors and communications protocols for connections, communications and power supply. The I²C is a multi-master serial single-ended computer bus that is used to attach low-speed peripherals to a motherboard, embedded system, cell phone, or other electronic device.

The ground power connection 202 provides a low impedance path to the earth to prevent hazardous voltages from appearing on equipment. The analog to digital converter 203 works by repeatedly measuring the amplitude (volume) of an incoming electrical pressure sound wave (an electrical voltage) and outputting these measurements as a long list of binary bytes. Further, the interrupt enable 204 is the control bit that tells the processor that a particular mask able interrupt should or should not be ignored.

FIG. 2b is a block diagram which depicts the external module interface architecture, as disclosed in the embodiments herein. The architecture comprises the Battery cover accessory (BCA) 207 that supports the standardized UART Interface 205 and a microcontroller 206. The BCA 207 is provided with a device driver thus eliminating the need for software updates on the mobile phone wherever there is a module connected to the mobile phone. The device driver of the BCA 207 has to be integrated with the micro controller 206 and not on the mobile phone. The microcontroller 206 comprises the BCA authentication interface. The connector connects to the BCA 207 pack with standardized UART (Universal Asynchronous Receiver/Transmitter) interface. A UART is a type of “asynchronous receiver/transmitter”, a piece of computer hardware that translates data between parallel and serial forms. UARTs are commonly used in conjunction with communication standards such as EIA, RS-232, RS-422 or RS-485.

The universal designation indicates that the data format and transmission speeds are configurable and that the actual electric signaling levels and methods (such as differential signaling and so on) typically are handled by a special driver circuit external to the UART. A UART is usually an individual (or part of an) integrated circuit used for serial communications over a computer or peripheral device serial port. UARTs are now commonly included in microcontrollers. A dual UART, or DUART, combines two UARTs into a single chip. Many modern ICs now come with a UART that can also communicate synchronously; these devices are called USARTs (universal synchronous/asynchronous receiver/transmitter). Further, UART can support reasonably higher data rates with software flow control and does not require a need to write driver to enable communication. The microcontroller system 206 is capable of communicating with different interface protocols such as I²C, UART, USB or SPI. Since the data interchange is of moderate magnitude, it would be sufficient to implement the UART as the standardized interface protocol between the phone and external module 205.

Further, the microcontroller 206 connects to the BCA implemented function over the required interface which may be I²C, UART, USB or SPI (serial peripheral interface). SPI is a synchronous serial data link that operates in full duplex mode. Devices communicate in master/slave mode where the master device initiates the data frame. Further, a Java enabled MIDP (Mobile information device profile) API (Application programming interface) or similar Open programming such as in iOS, Android or Windows Mobile is enabled on the phone to support the serial communication over the UART port to the accessory. The accessory device driver would be programmed on the microcontroller 206, thus avoiding any software updates on the phone firmware.

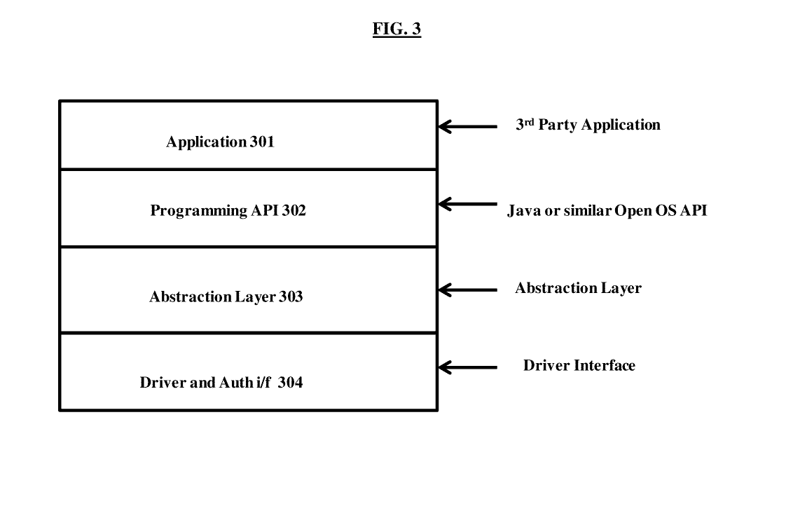

FIG. 3 is an exemplary diagram of the serial communication mechanism and API on the mobile phone, as disclosed in the embodiments herein. Further, in the process of serial communication mechanism the accessory would be connected through the microcontroller on a UART interface. The mobile phone platform may enable appropriate programming API 302 to support data interchange from the mobile phone to the accessory on the BCA. Further, the microcontroller 206 would be programmed with a driver and small interpreter code to enable this form of communication between the mobile phone and the accessory. By implementing an abstraction layer 303, the mobile phone may provide an open API 301 to third parties for implementing applications. The lower layer 303 is the native mode integration of the serial port programming as provided by the native platform. The Open API of 302 is abstracted on top of this. The data link layer 304 performs the data communication between the phone and the BCA. The data link layer is also embedded with an authentication mechanism to validate the accessory at the power on sequence.

In an embodiment, the BCA software development kit (or the external module) comprises of the combination of the following elements:
1. A serial communication mechanism and API from the mobile phone to the accessory or hardware element to be designed with a microcontroller.
2. An authentication mechanism to authorize the accessory using a proprietary key exchange between the mobile phone and the microcontroller 206 program. (The mechanism is purely for safeguard and licensing purposes).
3. An interface specification of the connector on the phone to the accessory hardware—including interfaces, signal and power levels.
4. Specifications and programming guidelines for the microcontroller 206.
5. A design guideline which allows the implementation of accessory with the microcontroller 206 as a conduit for data interchange and physical dimension specifications for the targeted product to help implement a battery cover based package.

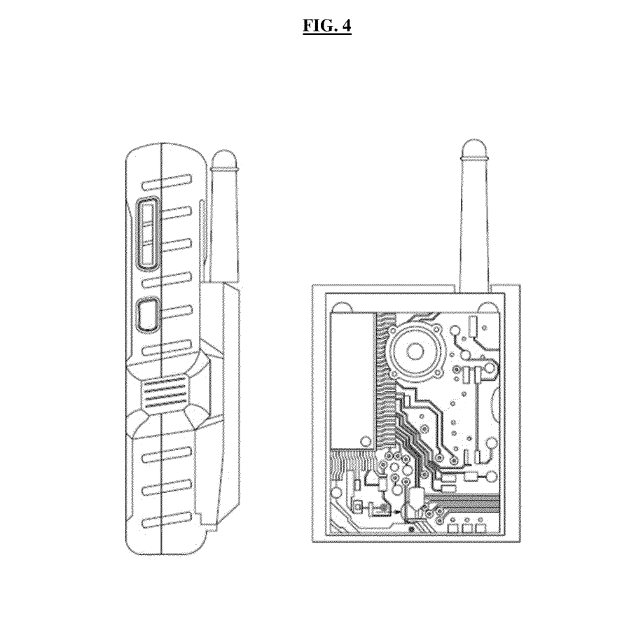

FIG. 4 illustrates the side view of the mobile phone and the external module interfaced to the battery cover, as disclosed in the embodiments herein. The embodiment herein discusses an example mobile phone that is equipped with the external interface module that sits in the battery cover of the mobile phone. As depicted, in the figure the left figure indicated the side view of the mobile phone equipped with the external interfacing module. In an embodiment, the external module integrates the open Family Radio Service. The mobile phone as seen is provided with a side button to facilitate push-to-talk function for the family radio service.

Further, as seen in the view of the battery cover is the external module integrated to the cover as a unified single unit. The external module comprises of the microcontroller and an inbuilt device driver. The microcontroller is equipped with the functionality to allow the enterprises to run enterprise specific applications and instructions on it. Further, the device driver will serve the requirements of new sub-modules integrated on the external module. The device driver enables serial communication with the mobile phone. As the driver is capable for serving any sub-module there are no software updates required on the mobile phone.

In an embodiment, the battery cover of the mobile phone is also provided with a connector to support the external module to reside within it. The battery cover together with the external module fit in as a single unified structure of the mobile phone. Further, when required the external module may be detached from the mobile phone.

The side view shown in FIG. 4 demonstrates the unified and ruggedized design of the BCA when integrated into the phone. The phone retains the unified form factor and rugged characteristics as before.

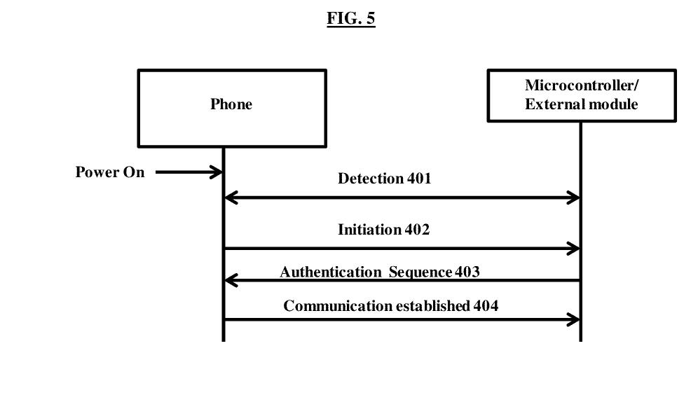

FIG. 5 is an exemplary diagram which illustrates the authentication mechanism as disclosed in the embodiments herein. The authentication mechanism detects 401 the availability of an accessory on the battery cover at the power ON mode and initiates 402 a key exchange sequence. Further, the authentication mechanism detects the authenticity 403 of the accessory and enables the data communication API to function once completed. The authentication mechanism enables 404 the mobile phone to adopt a licensing model and to ensure connection of trusted accessories. The authentication mechanism can also be used to protect the phone from improper or unsuitable designs. Further, the authentication mechanism also helps the mobile phone to understand the type of accessory to ensure that the designed accessory is in line with the specified electrical design requirements.

In an embodiment, the BCA interface specification is the complete set of hardware level information on the Connector bus from the mobile phone which is available for the design. The information such as the interface, type and power levels is specified. The accessory design must adhere to these specifications for reliable functioning. Further, connector bus also includes support for I²C in order to continue support for legacy battery cover accessories such as NFC (Near field communication). It also helps to integrate very simple low data sensor like accessories over I²C. The connector supports audio interfaces, but the data is not routed through the microcontroller 206. The audio API is enabled based on the authentication. Further, the mobile phone integrates the NFC antenna and chipset for card detection and processing. A java application may be used to process the NFC transactions.

In an embodiment, the microcontroller has many possible serial communication interfaces supported with different variants. The preferred one is the MSP430 from Texas Instruments. It supports UART, I2C, USB and SPI. The documentation and development tools will be provided along with the development kit.

In an embodiment, it is possible to harness the phone's processing capability by the BCA, by capturing data and getting it processed by the phone CPU by running the algorithms in the phone application. As an example a Camera BCA module can capture image in raw data and get it converted to jpeg formats by running the algorithm on the phone. Similarly, a finger print scanner could run the data processing on the phone side.

Design Guidelines

In an embodiment, the BCA SDK shall include the design guidelines for Microcontroller interfaces, Microcontroller programming, Power level limits, PCB layout dimensions. The design guidelines help the enterprise partners to build an accessory that functions with the BCA module.

Physical Dimensions

Finally, the module also provides limitations on physical dimensions so as to fit the accessory design into the battery cover dimensions of the product under target. The enterprise partner can design and integrate an accessory based function to the phone as a unified design. The accessory would fit into the battery cover forming a single phone unit enabling the phone with a new functionality.

In an embodiment, the example implementations of the accessories connected to the embedded interface are as follows. In an example, considering the FRS XPand Module. This module integrates the open Family Radio Service enabling module to the XP55xx based product family. The module replaces the standard battery cover. An enabling Java application performs the FRS scanning operations. The side button of the phone performs the push-to-talk operation for FRS.

Another example is the NFC XPand Module. This has been implemented in the NFC feature as a XPand module. The module integrates the NFC antenna and chipset for card detection and processing. The phone has Java application to process the NFC transactions.

The embodiments disclosed herein can be implemented through at least one software program running on at least one hardware device and performing network management functions to control the network elements. The elements shown in FIG. 3 include blocks which can be at least one of a hardware device, or a combination of hardware device and software module.

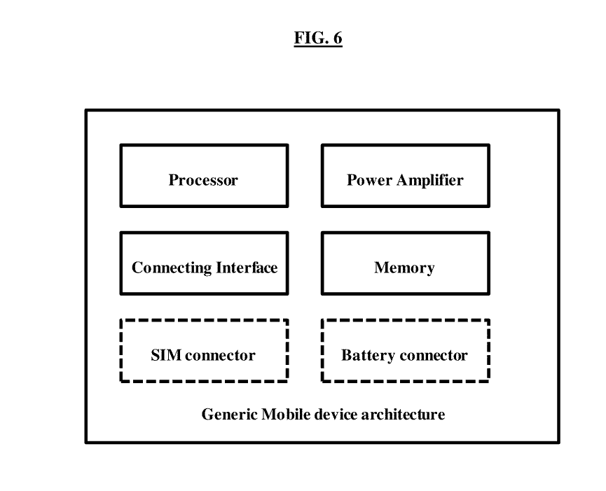

The embodiment disclosed herein specifies a system for implementation of an external interface for connecting modules to a mobile phone. FIG. 6 is a block diagram of a generic mobile device architecture which may be used in accordance with the embodiments herein. The mechanism allows building unified phone designs providing a system thereof. Therefore, it is understood that the scope of the protection is extended to such a program and in addition to a computer readable means having a message therein, such computer readable storage means contain program code means for implementation of one or more steps of the method, when the program runs on a mobile device or any suitable programmable device.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A mobile phone for providing a platform for interfacing an external module as a unified unit, said mobile phone provided with:
a connector for interfacing said external module to said mobile phone for communication with said external module;
an application programming interface on said mobile phone for supporting enterprise applications running on said external module; and
a mobile phone case to enable the combination of said connector and said external module to function as a single unit.

2. The mobile phone as in claim 1, wherein said connector comprises at least one of: data interface ports, power slots, audio output ports, signal interrupt ports.

3. The mobile phone as in claim 1, wherein said external module resides on the battery cover on said mobile phone as a single unit.

4. The mobile phone as in claim 1, wherein said external module resides as a detachable replaceable cover on said mobile phone together functioning as a single unit.

5. The mobile phone as in claim 1, wherein said application programming interface resides on an Open programming interface system, wherein said system includes at least one of Java, Symbian, Windows Mobile, Android, BREW on said mobile phone and supports third party applications.

6. The mobile phone as in claim 1, wherein said application programming interface specification on said mobile phone providing a simplified programming support for using the module supported functionality in a downloadable application.

7. An external module for supporting enterprise applications on a mobile phone, said module comprising:
at least one microcontroller programmed for enabling enterprise specific functionality on said module; and
a device driver residing on said module for supporting serial communications with the mobile phone.

8. The external module as in claim 7, wherein said module is embedded to the Battery Cover of said mobile phone.

9. The external module as in claim 7, wherein said external module resides as a detachable replaceable cover on said mobile phone together functioning as a single unit.

10. The external module as in claim 7, wherein said module provides authentication sub-module to authorize accessories connected to said module using a proprietary key exchange between said mobile phone and said microcontroller.

11. The external module as in claim 7, wherein said microcontroller is provided with design and programming guidelines and specification.

12. The external module as in claim 7, wherein said microcontroller is coupled to plurality of serial buses on said module for data exchange with said mobile phone.

13. The external module as in claim 7, wherein said module enables connecting sub-modules specific to enterprise applications, where said sub-module includes at least one of: sensors, radio module, near field communication modules.

14. The external module as in claim 7, wherein the said microcontroller is coupled to plurality of sub modules in order to support individually different functionalities to said mobile phone.

15. The external module as in claim 7, wherein the said module comprising of at least one of: microcontroller specification, integration software code, authentication mechanism and the design guidelines.
